(19) United States
(12) Patent Application Publication
(10) Pub. No.: US 2009/0103702 A1
(43) Pub. Date: Apr. 23, 2009

(54) Method and System of Communication with Identity and Directory Management

(75) Inventors: Malcolm Evatt Keith Allen, Victoria (AU); Gregory Rolan, Victoria (AU)

Correspondence Address: FITCH EVEN TABIN AND FLANNERY, 120 SOUTH LASALLE STREET, SUITE 1600, CHICAGO, IL, 60603-3406, US

(73) Assignee: Xynk Pty Ltd., Melbourne VIC (AU)

(21) Appl. No.: 11/908,572

(22) PCT Filed: Mar. 16, 2006
(86) PCT No.: PCT/AU2006/000354

§ 371 Date: May 5, 2008

(30) Foreign Application Priority Data
Mar. 17, 2005 (AU) 2005901323

(51) Int. Cl. H04M 1/56

(52) U.S. Cl. 379/142.04

(57) ABSTRACT

A communication system including a plurality of private directories containing information; and a plurality of public directory listings stored on a data network, each subscriber of the communication system having a private directory and at least one public directory listing, each public directory listing being configured to enable information requests for information from a target subscriber's private directory to be made by making requests to subscribers and to be reviewed by or on behalf of the target subscriber in order to determine what information, if any, will be supplied in response to the information request.

### FIELD OF THE INVENTION

The present invention relates to a communication system. In one aspect the communication system enables subscribers to have directory listings without revealing their identity. In another aspect, the communication system enables information requests to be reviewed by or on behalf of the subscriber.

### BACKGROUND TO THE INVENTION

In traditional communications networks, directory information is maintained centrally and a small amount of public data is held for each subscriber—for example, a name, telephone number and street address. The privacy of directory information of communications users of these traditional networks has not been particularly problematic. This is because using the small amount of public information for ‘brute force’ searching—i.e. contacting large numbers of subscribers to find an individual subscriber—can be expensive, for example because of the cost of making many calls may be high. Further, there is usually little harm that can occur as a result of unsolicited communication with a subscriber in such networks and subscribers can easily prevent most unwanted calls (albeit at some cost). For example if a subscriber receives unwanted calls over a traditional telephone network they can adopt a silent number to limit (but not eliminate) unwanted calls.

The Internet has facilitated the introduction of other forms of communication including but not limited to e-mail, Instant Messaging (IM) and Voice over Internet Protocol (VoIP) telephony. It will be appreciated that the fact that there is little or no cost to transmit information to an e-mail address is in part responsible for problems with unwanted e-mail known as SPAM. The SPAM problem has prevented the publishing of public e-mail address directories as these are too readily harvestable by spammers. Similar problems exist in relation to IM and VoIP directories as they rely on communication between IP addresses. Publishing IP addresses has the potential not only to lead to unwanted communication but also to other forms of attack on specific IP addresses.

Traditional directories are updated slowly, particularly paper based directories but Internet directories are typically not updated rapidly either. In many jurisdictions, communications providers were originally monopolies and so originally there was only a single entity responsible for maintaining directory information for the entire communications network. More recently, it has become common for there to be many different communications providers to which an individual may subscribe. Accordingly, in order to obtain directory information for an individual across all networks it is necessary either to search a number of different directories or to rely on an entity compiling a composite directory. In recent times, such composite directories have become accessible and searchable over the Internet. To date these directories only contain a subset of all possible directories and only for certain jurisdictions.

Thus it will be appreciated that an individual may possess a plurality of directory entries, across a plurality of directories representing the individual's subscription to and presence on a number of services—some of which may be subject to rapid, dynamic change.

Some attempts have been made to provide alternate systems for keeping personal composite directories up to date. Such systems typically rely on subscribers and their contacts going through a periodic e-mail or Internet update routine in order to update contact information held by a subscriber about them and require frequent synchronisation between a central server database and personal databases on subscriber computers. Often these servers enhance the directory information by enabling contacts and subscribers to add additional information to their directory entry, such as professional interests and resumes.

However these systems suffer from several sorts of problems.
1. There are scalability problems at the central database because of the need for all parties to obtain contact information from the central database at least periodically and the need for all requests to come via the same path.
2. Storing and processing contact information centrally affords the central agency a view of every subscriber and their relationships with other subscribers, which may not be desirable from a privacy perspective as the central agency has the opportunity to view all directory entries of all subscribers, without their knowledge.
3. Such directory services store static directory information and are not adapted to deal with situations where the directory information may change rapidly.
4. In order to update the server copy of the personal composite directory the server typically issues unsolicited requests for email updates to contact entries which some contacts regard as SPAM. The more frequently the contact information might change the greater the need to send out emails which only makes this problem worse.
5. Storing all contact information on the central database presents a systemic security risk in that if the central database is compromised (either through a technical attack, legal method, personnel misuse or other means) all contact information may become accessible without the knowledge or consent of the subscriber, contact or possible central agency. Also by observing the information flow occurring over the Internet to and from the server an observer may be able to deduce private information about subscribers and contacts without directly compromising the server or central agency.

These concerns have reduced the adoption rates of personal composite directory services over rates that they might otherwise achieve.

Peer-to-peer networks address some but not all of the shortcomings of centralised directories. Generally peer-to-peer networks are used to spread workload and data storage across multiple computers—and are typically employed to transfer files between peer nodes associated with file sharing applications. Nodes with files of interest are typically located by searching directories either stored on the node with the files or on a subset of nodes (super-nodes or super-peers) that contain directories of files stored on other nodes and the network addresses of those nodes.

A peer-to-peer network has the characteristic of physical machines constantly joining and leaving. As a machine joins it becomes a node or nodes on the network, which may have characteristics assigned to it by other nodes on the network and when it leaves these characteristics may be transferred to other nodes in the network. This has the effect that the actual physical machine on which a given node resides may change over time. Machines use peer-to-peer protocols to identify which machines may represent nodes not currently present and maintain updated information between them so that they each have current versions of information about nodes that they should contain, even as the machines representing nodes changes.

A problem with peer-to-peer networks is that when attempting to make a peer-to-peer connection, it is not possible to know with certainty that a connection does not exist—i.e. it may just have been missed in the search process because of the fluidity of the peer network.

### SUMMARY OF THE INVENTION

In a first broad aspect there is provided a communication system comprising:
a directory mechanism accessible via a data network and for storing directory listings for each of a plurality of subscribers; and
an identity-key generator for generating identity-keys of subscribers, each identity-key uniquely identifying a directory listing wherein identity-keys of subscribers are generated by applying a one-way algorithm to the identities of subscribers, the one-way algorithm being available to subscribers of the system, whereby a subscriber knowing an identity for a target subscriber can apply the one-way algorithm to the identity to obtain the corresponding identity-key and use this identity-key in order to submit an information request to the directory mechanism regarding the target subscriber.

Thus, target subscribers can be located without publishing directly in an easily browseable form the identities of the subscribers in the directory.

In a preferred embodiment, the directory mechanism comprises a plurality of public nodes, each located on a peer connected in a structured peer-to-peer network, each public node storing a directory list for a subset of subscribers to the directory. In this embodiment the directory list is typically keyed off the subscribers, identity keys.

In an alternative embodiment, the directory mechanism comprises a directory database stored on one or more servers accessible via the Internet.

Typically each public directory listing contains data to enable communications to be initiated with the identity while protecting the anonymity of the identity. Each directory listing may also contain active services which facilitate communications with the identity while protecting the anonymity of the identity.

The communication system may also have a system identity generator for generating system identities of subscribers, whereafter the identity-key generator generates identity-keys on the basis of the system assigned identity.

In this embodiment, system identities give an identity which is not maintained outside of the network. This is useful for some applications which may only exist in-band (such as advertisements between subscribers).

In a preferred embodiment the private directory maintains a master list of communications mechanisms for the subscriber with the private directory.

In a preferred embodiment, each private directory also stores directory information relating to how communication may be initiated with other subscribers.

In a preferred embodiment, the communication system further comprises a directory handler for handling information requests on the basis of one or more predetermined rules.

It is preferred that the directory handler dynamically updates the public directory information.

In the first broad aspect there is also provided a communication method comprising:
storing directory listings for each of a plurality of subscribers;
generating identity-keys of subscribers each identity-key uniquely identifying a directory listing, each identity-key uniquely identifying a directory listing wherein identity-keys of subscribers are generated by applying a one-way algorithm to identities of the subscribers; and
making the one-way algorithm available to subscribers of the system, whereby a subscriber knowing an identity for a target subscriber can apply the one-way algorithm to the identity obtain the corresponding identity-key and use this identity-key in order to submit an information request regarding the target subscriber.

In a second broad aspect there is provided a communication system comprising:
a data network comprising private and public nodes;
a plurality of private directories located on private nodes within a data network containing information; and
a plurality of public directory listings stored on public nodes of the data network, each subscriber of the communication system having a private directory located on a private node and at least one public directory listing located on a public node, each public directory listing being configured to enable information requests for information from a target subscriber's private directory to be made by making requests to subscribers and to be reviewed by or on behalf of the target subscriber in order to determine what information, if any, will be supplied in response to the information request.

Thus, the target subscriber has control over what information is released to searching subscribers.

In a preferred embodiment each public directory listing is provided by at least one public node having a public address, each public node being located on a peer connected in a structured peer-to-peer network.

Preferably, the private directories are provided on private nodes having a private address and the information requests are handled by the private node.

Thus, as the private addresses of the private nodes are not known they are not susceptible to attack and the corresponding public nodes do not have the private directories.

A number of different public directory listing configurations may be used to enable information requests to be reviewed by the corresponding private node. These configurations may either be used in different embodiments or in a single embodiment where the specific configuration chosen may depend, for example, on user choice or a system choice.

In one configuration the public node is configured to forward an information request directly to the private node.

In another configuration the public node is configured to forward the information request to a first relay node in a chain of relay nodes which will deliver the communication to the private node.

In another configuration the public node is configured to provide the network address of the first relay node of a relay chain which will deliver the information request to the private node to a requesting subscriber.

In another configuration the public node is configured to store information requests whereby the corresponding private node may periodically retrieve requests from the at least one public node, either directly or through a relay chain.

An information request may relate to directory information to enable communications to be initiated directly between subscribers. The information requests may also or alternatively relate to a searching subscriber seeking to update directory information for a target subscriber. In other embodiments, the information request may relate to other confidential information to be released on the basis of the identity of the searching subscriber.

In an embodiment, the communication system comprises an identity-key generator for generating identity-keys of subscribers on the basis of a subscriber identity, the identity-key enabling searching subscribers to locate a subscriber's public node.

In an embodiment, a private node comprises an identity-key generator which generates identity-keys on the basis of an existing subscriber identity by applying a one-way algorithm to the existing subscriber identity and then publishing the subscriber listing based on identity key into the public node directory.

In an embodiment, a private node comprises a directory handler for handling the information requests at least based on the identity of the requesting subscriber.

Thus, up to date or real-time directory information can be provided such as dynamic VoIP addresses, IN identifiers etc. The public nodes may also store other public information that subscribers do not wish to maintain as private, for example information already available in other public directories.

In the second broad aspect there is also provided a communication system wherein the system is configurable by subscribers to select a configuration so that either:
the public node is configured to forward an information request directly to the private node;
the public node is configured to forward the information request to a first relay node in a chain of relay nodes which will deliver the communication to the private node;
the public node is configured to provide the network address of the first relay node of a relay chain which will deliver the information request to the private node to a requesting subscriber; or
the public node is configured to store information requests whereby the corresponding private node may periodically retrieve requests from the at least one public node, either directly or through a relay chain.

### BRIEF DESCRIPTION OF THE DRAWINGS

FIG. 1 is a schematic diagram of a peer-to-peer network of a preferred embodiment.

### DESCRIPTION OF THE PREFERRED EMBODIMENT

The preferred embodiment provides a peer-to-peer network that is structured to allow subscribers to maintain anonymity while also allowing directory information to be managed and exchanged with both un-trusted and trusted peers including dynamic, presence information about the communications methods by which a subscriber can be contacted.

The preferred embodiment of the invention provides two main beneficial features:
1. A secure public directory in which entries may be found easily by authorised searchers but with extreme difficulty for unauthorised searchers. This directory is particularly amenable to both combining listings from multiple single-network based directories and to real-time updates, while being resistant to third-party correlation of multiple entries or sequential ‘harvesting’ of entries.
2. A method of listing the public directory entries in such a way as to protect the identity of both subscribers to the directory and searchers of the directory from un-trusted subscribers and searchers but still allow subscribers to the directory to list and update public entries, establish a trusted relationship between subscribers and searchers and easily maintain private directory entries between trusted subscribers and searchers.

It will be appreciated that searchers will typically be subscribers. The term “searcher” is predominantly used herein to avoid confusion between those carrying out the search and being searched for who are sometimes referred to herein as “target subscribers” for similar reasons.

The directory technique is particularly amenable to peer-to-peer networks, where individual peers cannot assume they are operating in a trusted environment and where the directory may be shared between many nodes.

### The Secure Directory

Each subscriber is assigned at least one Identity-Key. As will be explained in more detail below this may be assigned by the system directly assigning a system Identity to a subscriber or be determined from an existing Identity of the subscriber (for example via a digest or hash function). An existing Identity is a unique identifier or address for the subscriber which is identifiable outside of the system, such as an email address, mobile phone number or other identifier.

Directly assigned Identities will typically be associated with particular directory public listings in the system, such as a public classified advertisement.

In the preferred embodiment, each Identity-Key corresponds to each subscriber's public listing in the directory for that Identity or system-assigned Identity. In the preferred embodiment the public directory listing contains the following Listing Information:
The subscriber's Identity-Key
The subscriber's public key certificate;
The address of the first node in a Relay-Node chain which may route communication to be handled by this Identity or a request store if requests are not to be sent immediately to subscriber's but instead held in the store until retrieved by the subscriber;
Identifiers which will uniquely identify communication for this Identity and used by relay chains to determine routing, while protecting the anonymity of the subscriber;
Other information necessary for securing and routing communication;
Other information that may be used to confirm the listing as that of the subscriber (such as another digest of the subscriber's true address using a second digest function);
Other public information such as ‘white pages’ contact information or classified advertisements which the subscriber wishes to make public and which they wish to have associated with the Identity.

Persons skilled in the art will appreciate that in other embodiments, not all of the above items will be in the subscriber's public directory listing.

The subscriber maintains either directly or via some proxy (such as an always-on directory service) all other directory information which they wish to keep private and only disclose to searchers or classes of searchers on request, and possibly only after their identity has been verified.

In the preferred embodiment, before a directory entry based on a secure digest of an Identity is listed in the directory, a directory service first verifies the validity of the identity. This is done by sending an out-of-band message to the Identity (using the Identity's communications medium) asking for confirmation that the subscriber wishes to be listed in the directory under the digest of the Identity. In this way subscribers must authorise for their listings to be published in the directory using information only obtained from them privately over means outside of the system.

A searcher having knowledge of an Identity of a target subscriber and seeking directory information (for example, to establish communications with the target subscriber) may apply the public digest function (one-way) to the target subscriber's known Identity to obtain a potential Identity-Key for the target subscriber. By querying the directory they can establish if a listing for that subscriber based on that Identity exists in the directory.

In the case of a communications contact directory, a subscriber's Identities will typically be the communications addresses of the subscriber, for example an e-mail, IM or VoIP address, mobile (cell) phone number etc.

The public list of Identity-Keys along with their associated Listing Information represents the public directory provided by the preferred embodiment.

### The Listing of the Directory

In the preferred embodiment, the directory mechanism for storing the directory listings is provided by Public-Nodes of a structured peer-to-peer network.

Communication occurs between nodes. Nodes exist within peers. Communication is used to update directories of information about each subscriber and for other purposes as discussed below.

Peers are the primary software entities that make up the distributed directory network. A Peer may be considered as a ‘container’ in which a number of logical nodes run and interact across the network in various peer-to-peer contexts.

In the preferred embodiment a peer contains
0 or 1 DHT-Nodes (Distributed Hash Table Nodes)
0 or more Public-Nodes
0 or more Relay-Nodes
0 or 1 Private-Nodes

There are several types of nodes: DHT-Nodes, Public-Nodes, Private-Nodes and Public-Nodes all of which run within peers which may or may not participate in the peer-to-peer overlay network, represented by the distributed hash table of the peer network. If a node is not running on a DHT-Peer (see below) in the overlay network, it must connect to a DHT-Peer which will perform directory requests on its behalf—as a gateway or proxy. Nodes also may contain pointers which refer to other machines where nodes or information relating to nodes is stored.

DHT-Nodes interact with each other to form the (structured) Distributed Hash Table (DHT) overlay network which provides an address resolution and routing service. Each DHT-Node is identified by a session-unique Node-Number which is established when the DHT-Node joins the DHT overlay network.

DHT-Nodes service address-resolution queries, mapping Node-Numbers to network addresses. They also can route messages to the appropriate DHT-Node based on Node-Number and are responsible for responding to messages with a destination Node-Number within its Service Range—The Service-Range of a DHT-Node being the set of consecutive Node-Numbers, equal to or greater than its own Node-Number but less than the next highest Node-Number in the DHT.

A peer which has an instance of a DHT-Node running within it may be considered to be a DHT-Peer whereby all of its constituent nodes are associated with the Node-Number of its DHT-Node, and may respond to DHT-based traffic relayed within the peer by the DHT-Node.

In some embodiments, DHT-Nodes may participate in managing replicas of node data amongst DHT-Peers.

The Node numbers associated with the Distributed Hash Table provide a mechanism of allocating data identifiers and hence the data itself to nodes, affording efficient and deterministic storage and retrieval of data in a distributed manner. It should be noted that depending on the population of identifiers and the number and performance of nodes in a DHT, some DHT nodes may support many identifiers and others none. This means that as nodes join and leave the DHT, the node with primary responsibility for an identifier (and the identifier's associated data) may change.

Each Public-Node within the structured peer-to-peer network represents a single subscriber Identity and is locatable within the DHT via an Identity-Key derived from the Identity. Conversely, each subscriber Identity is represented by at least one Public-Node, each with an Identity-Key corresponding to the Identity. Subscribers may have more than one Public-Node per Identity for performance, reliability or other reasons but all of these Public-Nodes should be easily identifiable if the searcher knows the subscriber Identity or system assigned Identity-Key. That is, in this embodiment each Public-Node acts as a directory listing for the subscriber.

Public-Nodes may provide active services in addition to the listing information described in the previous section for a subscriber. For example, they may contain a store-and-forward service associated with the Identity whereby requests for Private-Node addresses, along with credentials supporting the request, may be deposited. A Public-Node's listing and services may be collectively termed the Public-Node's Facilities.

Each subscriber is allocated at least one Private-Node, the address of which is kept private and which contains the subscriber's private Directory-Handler for handling information requests from searchers seeking to obtain information from a target subscriber and to provide information about the subscriber to requesting searchers in accordance with rules specified by the subscriber.

In the preferred embodiment the information stored in the private directory provided by the Private-Node is directory information for enabling communications between the requesting searcher and target subscriber.

Private-Nodes are not locatable via the DHT, and though they may be located in a DHT-Peer, they do not participate in DHT-based traffic. If a Private-Node is not running on a DHT-Peer in the overlay network, it must connect to a DHT-Peer which will perform directory requests on its behalf as a gateway or proxy.

Each DHT-Node present on the network possesses a Node-Number which is a unique number within the DHT identifier space or ring. The DHT-Node's Node-Number is established when the DHT-Node joins the DHT overlay network and remains bound to the DHT-Node while the node remains connected. Upon disconnect the Node-Number is released and may be allocated to a (probably different) joining DHT-Node. Similarly if a DHT-Node re-joins the network it may be assigned a different Node-Number from the last time it was present on the network.

The Node-Number may be network assigned, by other peer nodes in the network, or assigned by a special server or class of servers or peers in the network. The Node-Number may be assigned based on performance characteristics of the network, of the peer and/or other characteristics. The Node-Number is assigned in the same number-space as that of the Identity-keys.

Nodes exchange information with each other to maintain an up-to-date listing of other Node-Numbers of interest and their physical network addresses.

A Node-Number corresponds to a possible Identity-Key in the Public-Node network. While a DHT-Peer supports zero or more Public-Nodes, it represents the set of all Identity-Keys in its Service-Range—whether each is associated with a Public-Node or not. In the preferred embodiment a DHT-Peer's Service Range is the Node-Number of the lowest Node-Number it contains up to (but excluding) the Node-Number of the next highest DHT-Peer's Service Range.

A peer not assigned at least one Node-Number (i.e. with no DHT-node) cannot run Public-Nodes but it can still run Private-Nodes and/or Relay-nodes.

Based on the Identity-Key derived from an Identity, a searcher can identify which peers and their physical addresses will represent a Public node of interest, if that node is present.

When the peer running a subscriber's Private-Node joins the network (either when it is assigned a Node-Number (DHT-Peer), or when it connects to a DHT-Peer gateway/Proxy (non DHT-Peer)) it establishes communication with all of the subscriber's Public-Nodes.

Those skilled in the art will recognise that other embodiments of the invention are possible. For example all Identity-Keys could be assigned to a single machine (a consolidated directory) with store & forward services and associated information located on other peers or servers.

Subscribers maintain privacy by communicating directly with Private-Nodes of only trusted subscribers and requiring un-trusted subscribers to at least initiate communication via at least one Public-Node.

Whether or not another subscriber is to be considered trusted or un-trusted is typically at the discretion of the subscriber based on the credentials they present but this may be facilitated by the software running on the target subscriber's Private-Node which may consider all other subscribers to be trusted, all un-trusted, or a mixture depending on an algorithm, typically with manual input into the determination.

In the preferred embodiment communications between un-trusted subscribers (i.e. between the nodes of un-trusted subscribers) employ a relay chain communications protocol that prevents the endpoint nodes from discovering the IP address of each other. For example, a protocol whereby nodes relay communications through at least two intermediate Relay-Nodes to prevent the sender, receiver or intermediate nodes from ever knowing more than one of the target or destination addresses. (Remembering that in some embodiments all subscribers may be treated as un-trusted and hence, it will not be necessary to distinguish between trusted and un-trusted subscribers). By using relay chains of indeterminate length (i.e. defined by the destination address) relay-nodes cannot be sure even of the sender or receiver address.

Depending on the embodiment, a Public-Node may:
automatically forward communication from an un-trusted subscriber to the target subscriber's Private-Node;
automatically forward communication from an un-trusted subscriber to the first Relay-Node in a chain of Relay-Nodes (relay chain) which will deliver the communication to the target subscriber's Private-Node;
provide to an un-trusted subscriber the network address of the first Relay-Node of a relay chain which will deliver the communication to the target subscriber's Private-Node; or
store communications requests whereby a Private-Node may periodically retrieve requests from the at least one Public-Node or nodes, either directly or through a relay chain. In this case requests may be stored only for a limited amount of time and/or for a limited number of requests.

Persons skilled in the art will appreciate that the first configuration referred to above is not as secure as it relies on the public node not being compromised, whereas configurations that store communications until picked up by a relay chain from a Private Node will not reveal the private node address even if compromised.

Those skilled in the art may recognise other embodiments, which are currently not preferred.

In the preferred embodiment, communication is protected by PKI encryption (i.e. whereby communication is signed with the sender's private key and encrypted with the recipient's public key, thus ensuring that only the sender could have sent the communication, and only the recipient is able to read it).

A subscriber wishing to initiate communication with a target subscriber will apply the public digest function to one of the target subscriber's Identities (or system-assigned identifier) to obtain the Identity-Key of the Public-Node for that Identity; query the DHT for the network address of the peer with the Identity-Key in its Service-Range; query the Public-Node on the peer for the facilities described above, and use the public information in the target subscriber's public directory listing (e.g. PKI certificate, relay address etc.) to initiate indirect communication to the target subscriber's Private-Node.

A subscriber may establish another trusted subscriber's presence on the DHT overlay network initially by trying the last known network address of the target subscriber's Private-Node. Should that fail to generate a satisfactory response the subscriber may use a Public-Node of the target trusted subscriber to initiate a request to establish communication. A successful response indicates that the target subscriber's Private-Node is present and then communications may be initiated directly between the trusted Private-Nodes. If no response is received to the request then the subscriber may re-initiate the request after a certain period.

In the preferred embodiment, the system is used to maintain directory information relating to communicating subscribers in such a manner that (1) it can be maintained independently by each subscriber and (2) it is released under control of each subscriber. In particular the directory information may be dynamically updated and may include rapidly changing information about subscribers. For example, to advise other subscribers as to the current ways in which the subscriber can be contacted—e.g. networks the target subscriber is present on or the real-time network address that they can be contacted on in a dynamically changing address environment such as a VoIP network.

To this end, each Private-Node has a Directory-Handler for handling directory requests from searchers seeking to communicate with a target subscriber and to provide directory information about the target subscriber to requesting searchers. It is preferred that the directory handler is configured to provide only directory information for which the requesting identity has permission. Accordingly, directory information may be provided differentially depending on the identity of the requesting searcher. For example, a private mobile phone number may only be provided to searchers that have been allocated the category of “friends” by the target subscriber whereas an e-mail address may be provided to all searchers.

In the preferred embodiment, requesting searchers maintain a local cache of request results of directory information and update the cache periodically by subsequent requests to target subscribers, or by direct updates sent from other subscribers, in order to refresh the directory information.

The Directory-Handler also processes requests from un-trusted subscribers to change their status to trusted and such requests may be processed in a number of manners, for example based on a configurable algorithm such as based on a look up of a directory already privately held by the subscriber or with some manual decision making by the target subscriber. Trusted peers may enjoy efficiencies of communication such as dispensing with communication relays, allowing direct, Private-Node to Private-Node communication.

In the preferred embodiment the Directory-Handler dynamically communicates changes to the target subscriber's information known for each trusted subscriber, directly to each trusted subscriber's Private-Node, for example to reflect changes in the target subscribers address or presence status on one or more networks as these change.

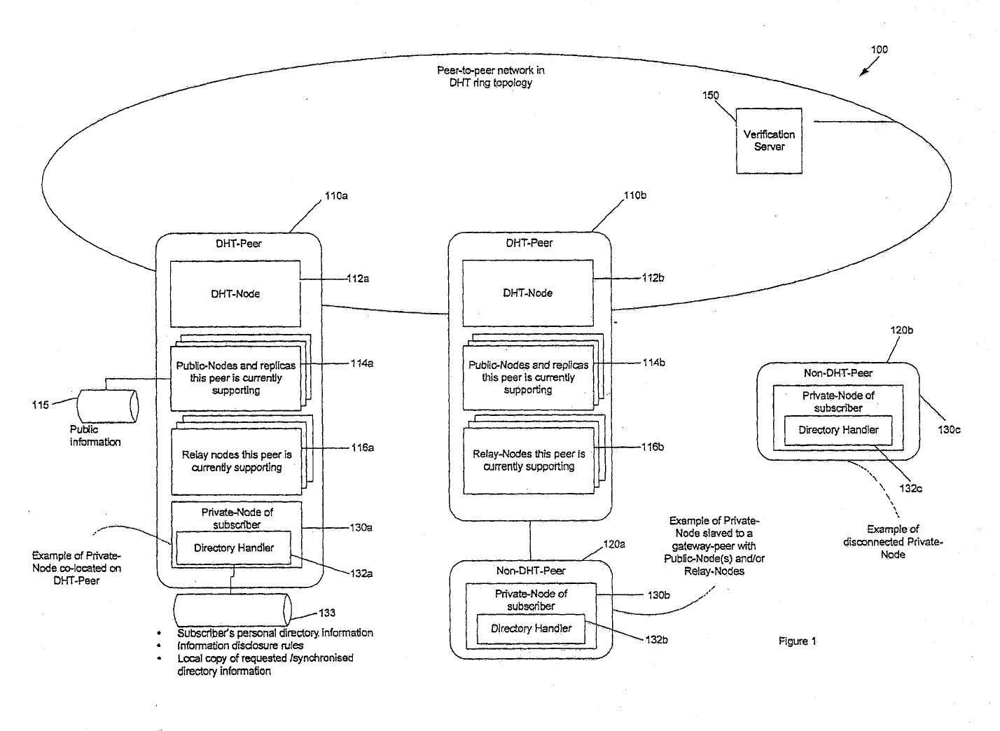

FIG. 1 is a schematic diagram illustrating a peer-to-peer network of the preferred embodiment which comprises:
A plurality of Peers connecting in a peer-to-peer numbered ring topology as per a typical DHT algorithm, each peer running
   0 or 1 DHT-Nodes
   0 or more Public-Nodes
   0 or more Relay-Nodes
   0 or 1 Private-Nodes
A verification service responsible for verifying subscribers and ensuring the integrity of information published on Public-Nodes.
A certificate authority for issuing signed PKI certificates allowing secure interaction between nodes.

As shown in FIG. 1, only DHT-peers 110 (i.e. those having DHT-nodes 112) form part of the structured peer-to-peer network 100.

FIG. 1 shows two typical examples of DHT-peers. DHT peer 110a has a DHT node 112a, a plurality of public nodes 114a which provide stored public information 115 to searches. The DHT-peer 110a also supports a number of relay nodes 116a.

A DHT-peer 110a may also support a private node 130a having a directory handler 132a and a store 133 of subscriber's personal directory information, information disclosure rules and a local copy of the requested/synchronised directory information.

Another DHT-peer 110b has a DHT node 112b, a number of public nodes 114b and a number of relay nodes 116b. However this DHT-peer does not support any private nodes 130. Instead, a non-DHT-peer 120a connects to the DHT-peer as a gateway to the DHT—i.e. the DHT-peer 110b acts as a proxy for the non-DHT-peer 120a. The non-DHT-peer 120a would typically host a private-node of a subscriber which includes its directory handler 132b. That is, the private node is slaved to gateway peer with public nodes and/or relay nodes.

Non-DHT-peer 120b is an example of a private node that is not currently connected to the peer-to-peer network and accordingly cannot be located via the DHT. The non-DHT-peer has the private node of the subscriber 130c and its directory handler 132c. The non-DHT-peer may join via a gateway DHT-peer as is the case of non-DHT-peer 120a or by joining the peer-to-peer topology as a DHT-peer by being allocated a DHT-node.

The network also comprises a verification server 150 having a known address which can be used to make out of band requests to verify the identity of the subscriber The verification server is typically provided with means for sending communication requests to the subscriber's identity when the subscriber attempts to join the network.

The network also comprises a certificate authority 160 which issues signed PKI certificates to nodes allowing them to identity themselves to other nodes by facilitating the use of PKI cryptographic techniques such as message encryption and signing. In the preferred embodiment, having verified an identity, the verification server 150 instructs the certificate authority 160, to issue a certificate to the identity's private node which can then establish its public node(s) and relay node(s).

While the design of the peer-to-peer network of the preferred embodiment is intended to allow all subscribers to maintain privacy, persons skilled in the art will appreciate that there may be some Private-Nodes that form part of the network that have been intentionally rendered public—e.g. the subscriber has published the peer's private network address as part of the subscriber's public information. Herein the term “Private-Node” is used to make it explicit that a subscriber intends for Private-Nodes to remain private, however, in general the description proceeds on the assumption that all subscribers intend to maintain privacy of their Private-Nodes.

Peers of the preferred embodiment have the typical characteristics of peer-to-peer network nodes such as the ability to interoperate from behind firewalls, deal with network address translations, bootstrap into the peer network, offer services to peers, rate the services offered by other peers and other services. In the preferred embodiment the term IP address relates to a plurality of addresses by which the peer-to-peer node may be contacted depending upon its location in the Internet and prevailing network security which may affect its representation in the Internet (e.g. network-address-translation, server tunnelling etc.)

In the preferred embodiment, peers typically run in two configurations:
DHT-Peers which comprise a DHT-Node, and zero or more Public-Nodes and Relay-Nodes, and (optionally) a Private-node—typically running on a desktop or server class machine connected to a low-cost broadband internet connection; and
Non-DHT-Peers which comprise only a Private-Node—typically running on a handheld device such as a PDA or mobile (cell) phone, typically not connected to a low-cost broadband internet connection.

Persons skilled in the art will recognise that other configurations are possible, for example, Public-Nodes and Relay-Nodes which run in non-DHT-Peers and which may be located via indirect references from entries stored in the DHT. Further, there is nothing to prevent a non-DHT-Peer from running on a desktop or server class machine.

In the preferred embodiment DHT-Nodes interact with each other to form the Distributed Hash Table (DHT) overlay network which provides an address resolution and routing service based on Node-Numbers. Each DHT-Node is identified by a session-unique Node-Number which is established when the DHT-Node joins the DHT overlay network.

Each DHT-Node is responsible for responding to messages with a destination Node-Number within its Service Range and relays inbound DHT-based traffic to other nodes in the peer.

Each DHT-Node also performs ‘housekeeping’ functions which avail themselves of the underlying DHT functionality to ensure network robustness is maintained—for example by maintaining replicas of data and tuning logical location in the DHT to minimise network latency, etc.

To participate in the network, a DHT-Peer undergoes a ‘join’ transaction whereby its DHT-Node identifies itself to the network of DHT-nodes, obtains a Node-Number (either through an internally generated algorithm or from the ‘join’ transaction with other peers or with a ‘join’ server that can provide the initial DHT) and requests insertion at a ring address corresponding to the Node-Number. This Node-Number is chosen to optimise performance of the DHT-Node which may ‘leave’ and re-‘join’ at a different ring address in order to optimise node performance of the ring. Once ‘join’ ed to the peer-to-peer network, the DHT-Peer supports zero or more Public-Nodes according to its Service-Range determined by the routing and balancing algorithms of the peer-to-peer network.

In this preferred embodiment, in order to participate in the network, a non-DHT-Peer, connects via a DHT-peer which acts as a ‘gateway’ or ‘proxy’ for the non-DHT-Peer's requests for DHT transactions.

In this preferred embodiment, each subscriber has one or more Identities and is represented by a Private-Node, the main component of which is the Directory-Handler. The Directory-Handler provides the following functions:
Maintaining the private directory;
Responding to requests for private directory information from other subscriber nodes;
Responding to requests for trusted status from other subscriber nodes;
Exchanging or synchronising directory information with trusted subscriber nodes; and
Maintaining a local copy of retrieved or synchronised directory information;

In the preferred embodiment, the Private-Node also has the functions of:
Initialising and updating public directory information for each of the subscriber's Identities on their associated Public-Nodes;
Initialising, updating and verifying the various communication Relay-Node chains; and
Providing a user interface for the subscriber to manage their Identities, associated directory information, and configuration rules for interactions with other subscribers;

Persons skilled in the art will appreciate that there are a number of ways these functions may be provided and associated with a Private-Node—for example, directly on a subscriber's personal computing device (machine), or by proxy in some form of client-server architecture.

Each Public-Node for a subscriber comprises the following functions:
Provision of a public storage area that is initialised and updated by subscriber's Private-Node with public information configured by the subscriber for a given Identity, the public node being identifiable by the subscriber's identity key. As discussed above, this information includes:
   The Identity's public key certificate;
   The address of the first node in the Relay-Node chain;
   An identifier which will uniquely identify communication for this identity;
   An identifier used to detect and resolve collisions resulting from the one-way digest function; and
   Other information such as ‘white pages’ contact information which the subscriber wishes to make public.

(The Public-Node will reply with this public information upon receipt of a query from any other node. Persons skilled in the art will recognise that there may be other embodiments which require additional information to be made public in such a manner.)
‘Housekeeping’ functions which ensure Relay-Node chains maintain their integrity for example by periodically sending ‘heartbeat’ communications to the associated Private-Node;

Persons skilled in the art will recognise that there are a number of other ‘housekeeping’ functions that may need to be provided by the Public-Node, it being a component of a distributed database running on a peer-to-peer overlay network.

The preferred embodiment also provides for Relay-Nodes which may run on DHT-Peers and non-DHT-Peers. A Relay-Node is configured by a Private-Node to relay communications it receives based on some configured criteria which may include a fixed relay destination; relay destination based on some identifier of the communication; relay destination embedded in the communications themselves; store-and-forward behaviour whereby the Relay-Node holds communications until retrieved by another node.

In the preferred embodiment, communication is delivered automatically to the next node in the relay chain and state information is not maintained in the network. If a node is not available to receive a communication, the communication will not be delivered. The use of multiple, redundant Relay-Node chains together with a systemic heart-beat is used to minimise communication breakdowns due to broken Relay-Node chains. Again, persons skilled in the art will recognise many variations on these relay criteria and additional criteria that may be employed to relay communications in addition to other transactional regimes to manage communication non-delivery.

As indicated above, the preferred embodiment also provides for a verification service 150 that is responsible for verifying subscriber Identities and a certificate authority 160 responsible for issuing and revoking certificates to/from verified identities enabling so that subscribers cannot spoof other's Identities and therefore directory information. In the preferred embodiment verification is achieved by a relevant out-of-band verification transaction—for example a password response to an email sent to an identifying e-mail address; or SMS to an identifying mobile (cell) phone number; or to a telephony application for identifying telephony transport addresses (PSTN, VoIP etc.) etc. Successful verification will result in the certificate authority signing a PKI certificate for the Identity which is then published on the Identity's Public-Node. Persons skilled in the art will recognise other mechanisms for identity verification and the subsequent control of subscription to the directory.

In the preferred embodiment, Public-Node addresses (Identity-Keys) are based on a one-way digest of a given Identity of a subscriber. Until a Public-Node is actually created for a subscriber Identity, that Identity-Key remains unused within the peer-to-peer network. Persons skilled in the art will appreciate that in order for the digest algorithm to be a one-way algorithm, it cannot involve a 1:N (N≧1) mapping between the subscriber Identity and the Identity-Key or else the digest algorithm could be easily discovered. The digest algorithm must in some instances produce the same Identity-Key for different subscriber Identities. These collisions can be dealt with in a number of different ways.

In the preferred embodiment, a value is stored in the Public-Node which is derived from the same subscriber Identity using a secondary digest algorithm to allow the Identity to be confirmed (the probability of two different digest algorithms both giving the same result when applied to the same subscriber Identity is infinitesimally small). If two different subscriber Identities result in the same Identity-Key (a collision in the digest number-space), a standard algorithm is applied to the subscriber identifier repeatedly until a unique Identity-Key is obtained—for example deterministically appending a series of suffixes to the subscriber Identity, repeating the one-way digest function, and checking for uniqueness. Persons skilled in the art will appreciate that other techniques can be used to allocate alternate Identity-Keys in the case of collisions, or indeed user's who have a colliding Identity-Key may be refused access to the system or required to provide an alternative subscriber Identity.

In the preferred embodiment, the subscriber software on the Private-Node, creates a PKI certificate corresponding to an Identity-Key and submits it to the verification service along with other data such as the Identity itself. The verification server then verifies the Identity via an out-of-band verification transaction described above. If verification is successful, the certificate authority 160 then signs the certificate for that Identity. The Private-Node then requests the peer-to-peer network to create a Public-Node for the Identity with an address corresponding to the Identity-Key and updates the Public-Node with public information as described above. This process is known as enrolment. Persons skilled in the art will recognise that there are many possible variations on this transaction flow, however out-of-band verification of the identifier and the creation of a Public-Node based on the one-way digest of the identifier remain central to the enrolment process.

In the preferred embodiment, for each associated Public-Node, the Private-Node sets up a Relay-Node chain from itself to the Public-Node for anonymous (in terms of the Private-Node's IP network address) updates to the Public-Node, the communications of which are secured via PKI encryption based on the subscriber's public key stored at the Public-Node. The Private-Node also sets up a Relay-Node chain to itself from an arbitrary initial node and updates the Public-Node with the address of this initial node. This relay chain is used for communication by an un-trusted requestor to the Private-Node. Persons skilled in the art will recognise that other Relay-Node topologies are possible.

Thus, if a subscriber knows Identity of a target subscriber and wishes to request the target subscriber for directory information, the requesting subscriber can determine the Public-Node address of identifier in the Public-Node ring.

To do so the requesting subscriber would:
1. Apply the one way digest function to the candidate target subscriber Identity to obtain the Identity-Key which is a potential Public-Node ring address;
2. Query the peer-to-peer network for public information corresponding to the Public-Node ring address with a value of the Identity-Key;
3. If public data is returned:
   a) Check the secondary digest data to ensure that the public information for the correct subscriber Identity is being referenced. If the secondary digest information indicates an identifier collision then apply the deterministic suffix algorithm to obtain the correct subscriber identifier and hence the correct Identity-Key for the subscriber Identity
   b) Use the public information to sign, encrypt and relay a request to the target subscriber's Private-Node.
   c) Check received communications for a response to the request.
4. If no public information is available for the identity-Key, then there has not been an enrolment for that identity in the directory.

If the requesting subscriber receives no reply to the request either:
a) The target subscriber's Private-Node is not available, in which case the request may be queued (with some timeout) to be sent repeatedly until the target subscriber's Private-Node becomes available and replies;
b) The target subscriber does not wish to communicate, in which case the requesting subscriber can send another request or give up; or
c) The request did not get through (this is mitigated by redundant relay chains and possibly by resending the request) in which case the requesting subscriber can send another request or give up.

In the preferred embodiment, all request and response messages are protected by PKI certificates to ensure integrity and non-repudiation—i.e. signed by the sender's private key and encrypted with the public key of the receiver (which is obtained from the receiver's Public-Node). In addition it is preferred that the communication state is retained only by the sender and communication only travels one-way along a Relay-Node chain. Thus, responses are communicated via the original sender's inbound relay chain, the initial node of which may be obtained from the sender's Public-Node public information.

Thus in the preferred embodiment, the target subscriber, upon receiving a communication from a requesting subscriber:
1. Determines whether to respond to the request and if so, formulates a response;
2. Derives the requestor subscriber's Identity-Key to obtain the Public-Node ring address corresponding to the requestor's Identity;
3. Queries the peer-to-peer network for public information corresponding to the derived Public-Node ring address;
4. If public data is returned (and it is expected that this will be so):
   a) Check the secondary digest data to ensure that the public information for the correct subscriber Identity is being referenced. If the secondary digest information indicates an identifier collision then apply the deterministic suffix algorithm to obtain the correct subscriber identifier and hence the correct Public-Node address for the subscriber Identity’
   b) Use the public information to sign, encrypt and relay the response to the requesting subscriber's Private-Node.

Once two subscribers have established communications via the standard Relay-Node chain they may elect to change the length of the relay chain between them for example by creating a new inbound Relay-Node chain and advising the other subscriber of the address of the initial node of the chain, or by dispensing with a relay chain altogether and establishing direct Private-Node to Private-Node communication.

In the preferred embodiment, a successful response to a request for establishing a ‘trusted’ status is a precondition for establishing direct Private-Node to Private-Node communication. While this can improve performance and reliability it can reduce confidentiality, hence the emphasis on being able to trust the other subscriber not to disclose the other subscriber's IP address or perform SPAM-like activity.

The process for trusted subscribers wishing to communicate is similar to the process described above for communicating with a new target user with the difference being that the requesting subscriber does not need to determine whether the target subscriber exists. If the locally cached directory information for a trusted target subscriber is stale (i.e. the target subscriber has changed addresses since the last update), the requesting subscriber can attempt to initiate communications as follows:
1. The requesting subscriber sends a communication request (which includes the requesting subscribers IP address) using the relay information in the target subscriber's Public-Node.
2 The target subscriber responds directly to the requesting subscriber with the target subscribers IP address.

There is a wide range of extensions of and applications for a dynamic, secure directory service as described herein. For example, in a telecommunications application it is possible for target subscribers to offer different out-of-band connection alternatives at the time of contact. For example a subscriber could be presented with a choice between connecting to a mobile telephone or via a VoIP connection. Alternatively, the network can be configured in order to present alternate options for terminating a call. For example, if the requesting user and target are located in different countries there may be an option to route the call to a mobile phone through a local IP gateway in the target user's country but have the call originated from the requesting user's VoIP phone service.

It will also be apparent that this technique can be used to dynamically control the directory information that is returned to requesting subscribers so that the target subscriber can control which available services are visible to requesting subscribers based on a wide variety of criteria. For example if home and office phone numbers are both linked by VoIP to a single subscriber IP address the target user may only want friends to have access to them at home and require business contacts to contact them only when they are in the office.

Accordingly, the directory handler for handling directory requests from subscribers to communicate with target subscribers is configured to provide only directory information for which the target peer is granted permission. To this end, the directory handler has a database and a function is provided to allow the ability to allocate different categories to persons in the database or indeed to classes of contacts. (For example, different levels of information may be available to persons sharing the same domain.)

One advantage of this directory structure is that it is kept up to date by subscribers and can be updated dynamically as subscriber information changes. Another advantage is that the information is highly distributed so that it is not as susceptible to a systematic attack.

The system can also be extended to allow conduct of online sales that allow the sellers of goods and services to remain anonymous even from the exchange where the good or services are offered or purchased. For example, a subscriber could be allocated a classified (in the sense of ‘yellow pages’ classifications) Public-Node based on a system assigned Identity-Key. Business could be initiated without having to know the Identity of the other party.

It will be appreciated that whereas traditional directories do not dynamically provide information based either on the identity of the entity requesting the information or on changes to the subscriber's details, the system of the preferred embodiment enables provision of information based on the identity of the requesting entity which can be supplied differentially depending on the entity which is requesting the contact information. Examples of where this might be useful are medical records retrieval applications or telecommunications connections applications. The preferred embodiment also makes it possible to update directory information at faster intervals than is possible with paper based directories or even Internet directories which are typically not updated rapidly. The invention handles directories for the increasing amount of directory information that may need to be kept for a given subscriber (e-mail addresses, dynamic VoIP addresses, IN identifiers, etc. in addition to fixed and mobile telephone numbers and street addresses) and the increasing frequency with which this information may change more easily than traditional directories.

In some embodiments the invention avoids a centralised collection of information which may be compromised and/or potentially provide a view of private subscribers and their relationships.

Finally it should be apparent that a secure, dynamic directory service which resolves the issues apparent with traditional directories is applicable to a wide range of classes of information other than communications contact addresses. In fact any information, which may be found via a public directory but only shared based on the identity of the requestor may be delivered through such a system.

Persons skilled in the art will readily understand various other applications of the invention and modifications that can be made to the above embodiment without departing from the scope of the invention described herein.

1. A communication system comprising:
a directory mechanism assessible via a data network and for storing directory listings for each of a plurality of subscribers; and
an identity-key generator for generating identity-keys of subscribers, each identity-key uniquely identifying a directory listing wherein identity-keys of subscribers are generated by applying a one-way algorithm to the identities of subscribers, the one-way algorithm being available to subscribers of the system, whereby a subscriber knowing an identity for a target subscriber can apply the one-way algorithm to the identity to obtain the corresponding identity-key and use this identity-key in order to submit an information request to the directory mechanism regarding the target subscriber.

2. A communication system as claimed in claim 1, wherein each directory listing contains data to enable communications to be initiated with the identity.

3. A communication system as claimed in claim 1 wherein each directory listing also contains active services which facilitate communications with the identity.

4. A communication system as claimed in claim 2 wherein the directory listing constitutes a public directory listing and there is provided a private directory for each subscriber that maintains a master list of communications mechanisms for the subscriber with the private directory.

5. A communication system as claimed in claim 4, wherein each private directory also stores directory information relating to how communication may be initiated with other subscribers.

6. A communication system as claimed in claim 1 wherein the communication system further comprises one or more directory handlers for handling information requests for information from a subscriber's private directory on the basis of one or more predetermined rules.

7. A communication system as claimed in claim 6, wherein the directory handler dynamically updates the public directory information.

8. A communication system as claimed in claim 1 further comprising a system identity generator for generating system identities of subscribers, whereafter the identity-key generator generates identity-keys on the basis of the system assigned identity.

9. A communication system as claimed in claim 1 wherein the directory mechanism comprises a plurality of public nodes, each located on a peer connected in a structured peer-to-peer network, each public node storing directory listings for a subset of subscribers to the directory.

10. A communication system as claimed in claim 1, wherein the directory mechanism comprises a directory database stored on one or more servers accessible via the Internet, the directory database storing directory listings for subscribers to the directory.

11. A communication system as claimed in claim 1, wherein the directory listings are configured to protect anonymity and privacy of the identity.

12. A communication method comprising:
storing directory listings for each of a plurality of subscribers;
generating identity-keys of subscribers each identity-key uniquely identifying a directory listing, each identity-key uniquely identifying a directory listing wherein identity-keys of subscribers are generated by applying a one-way algorithm to identities of the subscribers; and
making the one-way algorithm available to subscribers of the system, whereby a subscriber knowing an identity for a target subscriber can apply the one-way algorithm to the identity obtain the corresponding identity-key and use this identity-key in order to submit an information request regarding the target subscriber.

13. A communication method as claimed in claim 12, wherein each directory listing contains data to enable communications to be initiated with the identity.

14. A communication method as claimed in claim 12 wherein each directory listing also contains active services which facilitate communications with the identity.

15. A communication method as claimed in claim 13 wherein the directory listing constitutes a public directory and, the method comprises providing a private directory for each subscriber that maintains a master list of communications mechanismS for the subscriber with the private directory.

16. A communication method as claimed in claim 15, wherein each private directory also contains directory information relating to how communication may be initiated with other subscribers.

17. A communication method as claimed in claim 12 comprising handling information requests for information from a subscriber's private directory on the basis of one or more predetermined rules.

18. A communication method as claimed in claim 17, comprising dynamically updates the public directory information.

19. A communication method as claimed in comprising generating system identities of subscribers, whereafter the identity-key generator generates identity-keys on the basis of the system assigned identity.

20. A communication method as claimed in claim 11, wherein the directory listing is configured to protect the anonymity of the identity.

21. A communication system comprising:
a data network comprising private and public nodes;
a plurality of private directories located on private nodes within a data network containing information; and
a plurality of public directory listings stored on public nodes of the data network, each subscriber of the communication system having a private directory located on a private node and at least one public directory listing located on a public node, each public directory listing being configured to enable information requests for information from a target subscriber's private directory to be made by making requests to subscribers and to be reviewed by or on behalf of the target subscriber in order to determine what information, if any, will be supplied in response to the information request.

22. A communication system as claimed in claim 21, wherein each public directory listing is provided by at least one public node having a public address, each public node being located on a peer connected in a structured peer-to-peer network.

23. A communication system as claimed in claim 22, wherein the private directories are provided on private nodes having a private address and the information requests are handled by the private node.

24. A communication system as claimed in claim 23, wherein the public node is configured to forward an information request directly to the private node.

25. A communication system as claimed in claim 23, wherein the public node is configured to forward the information request to a first relay node in a chain of relay nodes which will deliver the communication to the private node.

26. A communication system as claimed in claim 23, wherein the public node is configured to provide the network address of the first relay node of a relay chain which will deliver the information request to the private node to a requesting subscriber.

27. A communication system as claimed in claim 23, wherein the public node is configured to store information requests whereby the corresponding private node may periodically retrieve requests from the at least one public node, either directly or through a relay chain.

28. A communication system as claimed in claim 23, wherein the system is configurable by subscribers to select a configuration so that either:
the public node is configured to forward an information request directly to the private node;
the public node is configured to forward the information request to a first relay node in a chain of relay nodes which will deliver the communication to the private node;
the public node is configured to provide the network address of the first relay node of a relay chain which will deliver the information request to the private node to a requesting subscriber; or
the public node is configured to store information requests whereby the corresponding private node may periodically retrieve requests from the at least one public node, either directly or through a relay chain.

29. A communication system as claimed in claim 21 wherein an information request relates to directory information required to enable communications to be initiated directly between subscribers.

30. A communication system as claimed in claim 21 wherein an information request relates to a searching subscriber seeking to update directory information for a target subscriber.

31. A communication system as claimed in claim 21 wherein the information request relates to confidential information to be released on the basis of the identity of the searching subscriber.

32. A communication system as claimed in claim 22 further comprising an identity-key generator for generating identity-keys of subscribers on the basis of a subscriber identity, the identity-key enabling searching subscribers to locate a subscriber's public node.

33. A communication system as claimed in claim 23 further comprising a private node identity-key generator which generates identity-keys on the basis of an existing subscriber identity by applying a one-way algorithm to the existing subscriber identity and then publishing the subscriber listing based on identity key into the public node directory.

34. A communication system as claimed in claim 23 wherein each private node comprises a directory handler for handling the information requests at least based on the identity of the requesting subscriber.

35. A communication method comprising:
providing a plurality of private directories containing information on private nodes of a data network; and
providing a plurality of public directory listings stored on public nodes of the data network, the public directory listings and private directories being provided such that each subscriber has a private directory located on a private node and at least on public directly listing located on a public node, wherein public directory listings allow searching subscribers to make information requests for information from a target subscriber's private directory to be made by searching subscribers and the private directories allow information requests to be reviewed by or on behalf of the target subscriber in order to determine what information, if any, will be supplied in response to the information request.

36. A communication method as claimed in claim 35, wherein each public directory listing is provided by at least one public node having a public address, each public node being located on a peer connected in a structured peer-to-peer network.

37. A communication method as claimed in claim 36, wherein the private directories are provided on private nodes having a private address and the method involves handling of information requests by the private nodes.

38. A communication method as claimed in claim 37, comprising the public node forwarding an information request directly to the private node.

39. A communication method as claimed in claim 37, comprising the public node forwarding the information request to a first relay node in a chain of relay nodes which will deliver the communication to the private node.

40. A communication method as claimed in claim 37, comprising the public node providing the network address of the first relay node of a relay chain which will deliver the information request to the private node to a requesting subscriber.

41. A communication method as claimed in claim 40, comprising the public node storing information requests and the corresponding private node periodically retrieving requests from the at least one public node, either directly or through a relay chain.

42. A communication method as claimed in claim 37, comprising selectively configuring the public node to either:
forward an information request to a first relay node in a chain of relay nodes which will deliver the communication to the private node;
provide the network address of the first relay node of a relay chain which will deliver the information request to the private node to a requesting subscriber; and
store information requests whereby the corresponding private node may periodically retrieve requests from the at least one public node, either directly or through a relay chain.

43. A communication method as claimed in claim 35 further comprising generating identity-keys of subscribers on the basis of a subscriber identity, the identity-key enabling searching subscribers to locate a subscriber's public node.

44. A communication method as claimed in claim 35 comprising processing information requests at least based on the identity of the requesting subscriber.
